(19) United States
(12) Patent Application Publication
(10) Pub. No.: US 2015/0245243 A1
(43) Pub. Date: Aug. 27, 2015

(54) SHORT REQUEST TO SEND FRAME

(71) Applicant: QUALCOMM Incorporated, San Diego, CA (US)

(72) Inventor: Maarten Menzo Wentink, Naarden (NL)

(21) Appl. No.: 14/625,401

(22) Filed: Feb. 18, 2015

Related U.S. Application Data
(60) Provisional application No. 61/943,816, filed on Feb. 24, 2014.

(51) Int. Cl. H04W 28/04; H04W 76/02

(52) U.S. Cl. CPC H04W 28/042; H04W 76/02; H04W 28/06

(57) ABSTRACT

Methods, systems, and devices are described for reducing overhead of control frame messaging associated with response policy indication. A method for wireless communication may include transmitting a control frame with the control frame including a physical layer (PHY) header and at least one medium access control (MAC) protocol data unit. The method may also include indicating a first response policy for the MAC protocol data unit in the PHY header, with the first response policy superseding a second response policy for the MAC protocol data unit associated with the MAC protocol data unit. The PHY header may include a synchronization block that includes a reduced set of synchronization bits different from an expanded set of synchronization bits.

### CROSS REFERENCES

The present Application for Patent claims priority to U.S. Provisional Patent Application No. 61/943,816 by Wentink, entitled “Short RTS,” filed Feb. 24, 2014, assigned to the assignee hereof, and expressly incorporated by reference herein.

The present Application for Patent is related to the following co-pending U.S. patent application: “Short Request to Send Frame” by Wentink, having Attorney Docket No. 14316U2, filed concurrently herewith, assigned to the assignee hereof, and expressly incorporated by reference herein.

### BACKGROUND

1. Field of the Disclosure

The following relates generally to wireless communication, and more specifically to improving efficiency for response policy or acknowledgement (ACK) messaging.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Wireless Local Area Networks (WLANs), such as Wi-Fi (IEEE 802.11) networks are widely deployed and used. Other examples of such multiple-access systems may include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations or access points (APs), each simultaneously supporting communication for multiple mobile devices or stations (STAs). APs may communicate with STAs on downstream and upstream links. Each AP has a coverage range, which may be referred to as the coverage area of the cell. One mechanism used in 802.11 systems include communicating one or more control frames prior to establishing a communication link, such that confirmation of the communication link via exchange of control frames limits interference experienced by nearby communication devices. One example of such techniques includes Request to Send (RTS) and Clear to Send (CTS messaging, where, for example, a STA looking to communicate with another device (e.g., another STA or AP), may first send an RTS frame to the device.

Once the recipient device receives the RTS frame, the recipient device may confirm the communication link by sending a CTS frame. After the CTS frame is received by the STA, the STA may then begin transmitting data to the recipient device. In this way, RTS/CTS messaging can reduce frame collisions by enabling a device, such as a STA or AP, to in essence clear the communication path before transmitting data to an AP or STA. RTS/CTS techniques may be particularly helpful when there are multiple STAs in a congested area (e.g., where there is a large number of STA/APs transmitting messaging in close proximity, etc.) and when there exists a “hidden node.” However, current RTS/CTS techniques can increase overhead, introduce delays, and reduce throughput.

### SUMMARY

The described features generally relate to one or more improved systems, methods, and apparatuses for reducing the overhead imposed by one or more control frames indicating response policy information, such as control frames implementing RTS/CTS techniques. In particular, a method for wireless communication may include transmitting a control frame, with the control frame including a Physical layer (PHY) header and at least one Medium Access Control (MAC) protocol data unit (MPDU). A first response policy may be indicated in the PHY header for the at least one MPDU that supersedes a second response policy for the at least one MPDU associated with the at least one MPDU. The control frame may be transmitted in place of a traditional RTS frame as described above to access a wireless medium and to initiate establishment of a communication link. Indicating a first response policy in the PHY header of the control frame may reduce the size of the control frame, such that the control frame utilizes fewer resources than a traditional RTS frame. A modified CTS frame, such as a Response Requested Clear to Send (RCTS) frame, may be used with the PHY header indicating the first response policy in place of an RTS frame.

A response to the control frame may be received in accordance with the first response policy indicated in the PHY header of the control frame. The response may be a CTS frame or an ACK frame or message. Once the CTS or ACK frame is received, one or more data frames may be transmitted over the wireless medium based at least in part on the received CTS or ACK frame.

The MPDU may include one of a CTS or an ACK message. The PHY header may include a service field, and indicating the first response policy in the PHY header may include setting a bit in the service field based at least in part on the first response policy. The bit set in the service field of the PHY header may be separate from at least one high rate (HR) direct sequence spread spectrum (DSSS) bit in the service field of the PHY header. The response policy may include one of a request for a response or an instruction or indication for the recipient device to follow the response policy associated with the at least one transmitted MPDU. The second response policy associated with the at least one MPDU may include an ACK policy of the MPDU.

The PHY header of the control frame may include a synchronization block that includes a reduced set of synchronization bits. The PHY header may include a start frame delimiter (SFD) field that indicates that the synchronization block includes an expanded set of synchronization bits different from the reduced set of synchronization bits. The synchronization block itself may indicate that the expanded set of synchronization blocks is included in the synchronization block of the PHY header. The reduced set of synchronization bits in the synchronization block of the PHY header may further reduce the overhead of the control frame and as a result, increase the efficiency of control frame or RTS/CTS messaging, while still being backwards compatible with systems that are configured to receive control frames with the expanded set of synchronization bits.

The PHY header may include a signal field, a service field, a length field, and a cyclic redundancy check field. The synchronization block and the SFD field may indicate that the signal field, the service field, the length field, and the cyclic redundancy check field are transmitted at 1 Mbps.

The PHY header may include a signal field, a service field, a length field, and a cyclic redundancy check field. The synchronization block and the SFD field may indicate that the signal field, the service field, the length field, and the cyclic redundancy check field are transmitted at 1 Mbps.

A wireless communications apparatus may include a transmitter to transmit a control frame including a PHY header and at least one MPDU, and a response policy manager to indicate a first response policy for the MPDU in the PHY header, the first response policy superseding a second response policy for the MPDU associated with the MPDU.

In certain examples, the wireless communications apparatus may implement one or more aspects of the method described above.

An apparatus for wireless communication may include means for transmitting a control frame, the control frame including a PHY header and at least one MPDU. The apparatus may also include means for indicating a first response policy for the MPDU in the PHY header, the first response policy superseding a second response policy for the MPDU associated with the MPDU.

In certain examples, the apparatus for wireless communications may implement one or more aspects of the method or apparatus described above.

A non-transitory computer-readable medium may store instructions executable by a processor to cause a device to transmit a control frame, the control frame including a PHY header and at least one MPDU. The instructions may be further executable by the processor to cause the device to indicate a first response policy for the MPDU in the PHY header, the first response policy superseding a second response policy for the MPDU associated with the MPDU.

In certain examples, the instructions may be configured to cause the processor to implement one or more aspects of the method or apparatuses described above.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an example of a wireless communications system, in accordance with various embodiments;

FIG. 2 shows an example of an exemplary wireless communication system including a Station (STA) and an Access Point (AP), in accordance with various embodiments;

FIG. 3 shows a process flow diagram illustrating exemplary communications between an STA and an AP, in accordance with various embodiments;

FIGS. 4A-4B show examples of exemplary Request to Send (RTS) control frames, in accordance with various embodiments;

FIG. 5A shows an example of an exemplary expanded Physical layer (PHY) header, in accordance with various embodiments;

FIGS. 5B-5C show examples of exemplary reduced Physical layer (PHY) headers, in accordance with various embodiments;

FIGS. 6A-6B show examples of exemplary Service Fields of a PHY header, in accordance with various embodiments;

FIGS. 7A-7B show examples of exemplary control frames with a response policy indicated in the Service Field of the PHY header, in accordance with various embodiments;

FIG. 8 shows an example of communications between two STAs, in accordance with various embodiments;

FIG. 9 shows a block diagram of an example of a device configured for indicating a response policy in the PHY header of a control frame, in accordance with various embodiments;

FIG. 10 shows a block diagram of another example of a device configured for indicating a response policy in the PHY header of a control frame, in accordance with various embodiments;

FIG. 11 shows a block diagram of another example of a device configured for indicating a response policy in the PHY header of a control frame, in accordance with various embodiments; and

FIGS. 12-14 show flowcharts of methods for reducing the overhead imposed by one or more control frames indicating response policy information, in accordance with various embodiments.

### DETAILED DESCRIPTION

The described features generally relate to one or more improved systems, methods, and apparatuses for reducing the overhead imposed by one or more control frames indicating response policy information, such as control frames implementing RTS/CTS techniques. In particular, a control frame may be transmitted, for example by a STA to an AP to establish a communication link, with the control frame including a Physical layer (PHY) header and at least one Medium Access Control (MAC) protocol data unit (MPDU). A first response policy may be indicated in the PHY header for an MPDU that supersedes a second response policy for the MPDU associated with the MPDU. The control frame may be transmitted in place of a traditional RTS frame as described above to access a wireless medium and to initiate establishment of a communication link. Indicating a first response policy in the PHY header of the control frame may reduce the size of the control frame, such that the control frame utilizes less resources than a traditional RTS frame. A modified CTS frame, such as a Response Requested Clear to Send (RCTS) frame, may be used with the PHY header indicating the first response policy in place of an RTS frame.

The STA, for example, may receive a response to the control frame, such as from an AP or another STA, in accordance with the first response policy indicated in the PHY header of the control frame. The response may be a CTS frame or an ACK frame or message. The STA may then transmit one or more data frames over the wireless medium based at least in part on the received CTS or ACK frame.

It should be appreciated that a STA sending a control frame to an AP via the techniques described above is given only as an example. A STA may send a control frame to another STA to initiate the establishment of a communication link between the two STAs. An AP may also send the control frame, for example, to initiate the establishment of a communication link with one or more STAs.

A method for wireless communication may include transmitting a control frame including a PHY header and at least one MPDU. The PHY header may include a synchronization block, with the synchronization block including a reduced set of synchronization bits different from an expanded set of synchronization bits. The PHY header may include a start frame delimiter (SFD) field that indicates that the synchronization block includes an expanded set of synchronization bits different from the reduced set of synchronization bits. The synchronization block itself may indicate that the expanded set of synchronization blocks is included in the synchronization block of the PHY header. In this way, overhead of the control frame may be reduced by using a reduced set of synchronization bits, while still being backwards compatible with systems that are configured to receive control frames with the expanded set of synchronization bits.

The following description provides examples and is not limiting of the scope, applicability, or configuration set forth in the claims. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments. As referred to herein, a WLAN connection or link may be synonymous with a Wi-Fi, Wi-Fi Direct or Wi-Fi P2P connection or group, Wi-Fi Display, Miracast, or other WLAN communication technologies. For the purposes of explanation, the described methods, systems, and devices refer specifically to WLAN; however, other radio communication or access technologies may be compatible with and implemented using the described techniques. Furthermore, as used throughout this application, the term control frame may refer to a control frame (e.g., an RTS, CTS, ACK frame, etc.), a data frame, a management frame, or any other similarly designated frame. For ease of reference, control frame will be used to refer to the above-mentioned frames collectively.

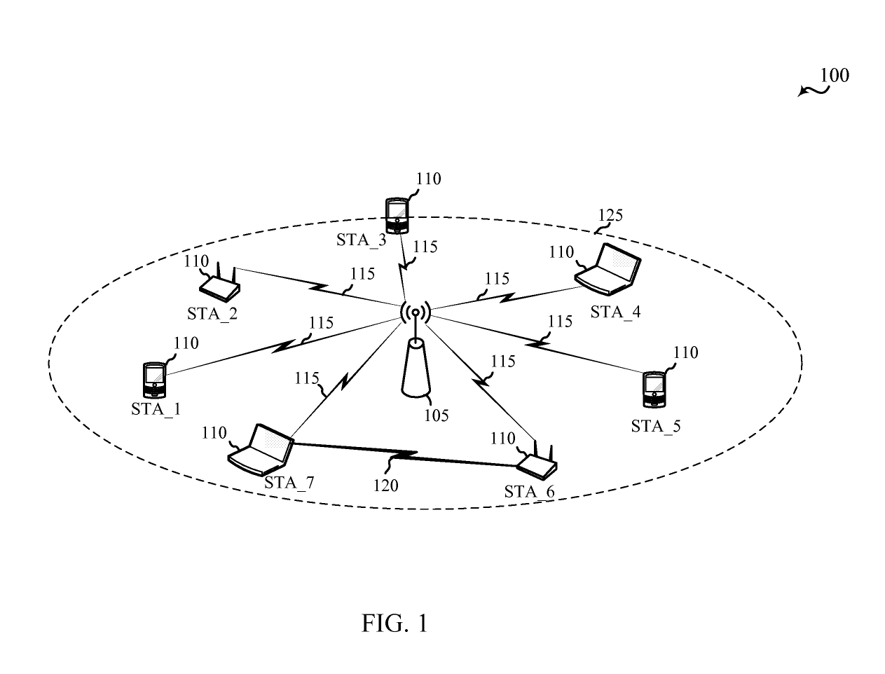

Referring first to FIG. 1, a block diagram illustrates a network 100 that may be an example of a WLAN or Wi-Fi network such as, e.g., a network implementing at least one of the IEEE 802.11 family of standards. The network 100 may include an access point (AP) 105 and one or more wireless stations (STAs 110) labeled as STA_1 through STA_7. The wireless devices may be referred to as mobile handsets, personal digital assistants (PDAs), other handheld devices, netbooks, notebook computers, tablet computers, laptops, desktop computers, display devices (e.g., TVs, computer monitors, etc.), printers, etc. While only one AP 105 is illustrated, the network 100 may have multiple APs 105. Each of the STAs 110, which may also be referred to as a wireless station, a station (STA), a mobile station (MS), a mobile device, an access terminal (AT), a user equipment (UE), a subscriber station (SS), or a subscriber unit, may associate and communicate with an AP 105 via a communication link 115. Each AP 105 has a coverage area 125 such that STAs 110 within that area can typically communicate with the AP 105. The STAs 110 may be dispersed throughout the coverage area 125. Each STA 110 may be stationary or mobile.

Although not shown in FIG. 1, a STA 110 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) (not shown) is used to connect APs 105 in an extended service set. A coverage area 125 for an AP 105 may be divided into sectors making up only a portion of the coverage area (not shown). The network 100 may include APs 105 of different types (e.g., metropolitan area, home network, etc.), with varying sizes of coverage areas and overlapping coverage areas for different technologies. Although not shown, other wireless devices can communicate with the AP 105.

While the STAs 110 may communicate with each other through the AP 105 using communication links 115, each STA 110 may also communicate directly with one or more other STAs 110 via a direct wireless communication link 120. Two or more STAs 110 may communicate via a direct wireless communication link 120 when both STAs 110 are in the AP coverage area 125, when one STA 110 is within the AP coverage area 125, or when neither of the STAs 110 is within the AP coverage area 125 (not shown). Examples of direct wireless communication links 120 may include Wi-Fi Direct connections, connections established by using a Wi-Fi Tunneled Direct Link Setup (TDLS) link, and other P2P group connections. The STAs 110 and APs 105 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other peer-to-peer connections or ad hoc networks may be implemented in network 100.

The AP 105 or one or more of STAs 110 of network 100 may be configured to use control frame messaging, such as RTS/CTS messaging, to initiate establishment of a communication link, in accordance with the techniques described herein. A STA 110 may transmit a control frame including a PHY header and an MPDU, for example, to another STA 110 or AP 105 to request access to the wireless medium and initiate establishment of a communication link 120, 115. The STA 110 may configure the PHY header to indicate a first response policy for the MPDU that supersedes a second response policy for the MPDU associated with the MPDU, such as an ACK policy of the MPDU. The control frame may be transmitted by the STA 110 in place of an RTS frame. Additionally or alternatively, the STA 110 may configure a synchronization block of the PHY header of the control frame to include a reduced set of synchronization bits different from an expanded set of synchronization bits. By using these methods the STA 110 may reduce the overhead of a control frame indicating a response policy for initiating the establishment of a communication link with another device, such as another STA 110 or an AP 105.

The AP 105 may also implement the techniques described above by transmitting a control frame including a PHY header and at least one MPDU, for example, to a STA 110. The AP 105 may configure the PHY header to indicate a first response policy for the MPDU that supersedes a second response policy for the MPDU associated with the MPDU, as similarly described above with respect to the STA 110. Additionally or alternatively, the AP 105 may configure a synchronization block of the PHY header of the control frame to include a reduced set of synchronization bits different from an expanded set of synchronization bits. Thus, both an AP 105 and a STA 110 may realize one or more benefits in utilizing the described techniques, such as reduced overhead of response policy messaging, increased throughput, and reduced delay in establishing a communication link.

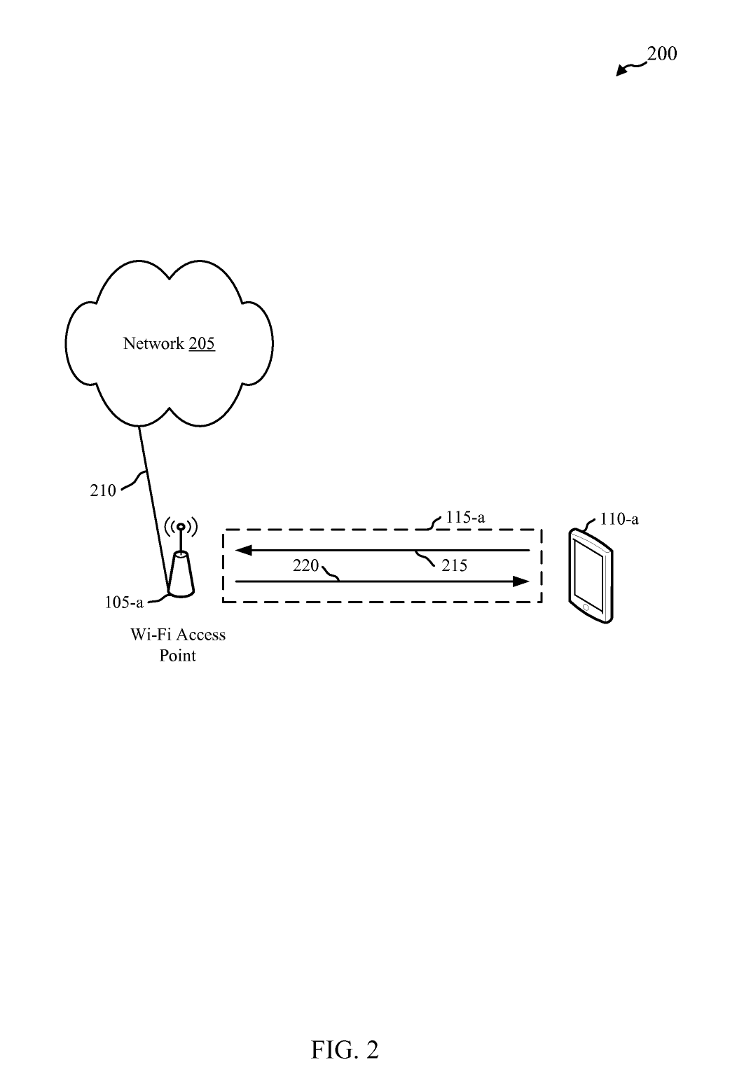

Referring now to FIG. 2, a system 200 includes an AP 105-a in communication with a mobile device or STA 110-a via communication link 115-a. AP 105-a and STA 110-a may be examples of AP 105 and STA 110 described above in reference to FIG. 1. Furthermore, system 200 may be an example of or a portion of network 100 described in reference to FIG. 1. The AP 105-a may be in communication with a network 205 via a communication link 210, such as a backhaul link, which may be wireless or wired. The AP 105-a may communicate with STA 110-a via communication link 115-a, for example implementing a WLAN technology, such as Wi-Fi.

The STA 110-a may have data to communicate to the AP 105-a. To initiate establishment of a communication link 115-a between the STA 110-a and the AP 105-a, the STA 110-a may first configure one or more control frames, for example one or more RTS frames. The STA 110-a may send the one or more control frames 215 to confirm the communication link 115-a with the AP 105-a before sending data to the AP 105-a. By first sending the control frame to the AP 105-a, the STA 110-a may reduce interference received from other devices (not shown) or may reduce interference caused to other devices. The AP 105-a may receive the one or more control frames 215 and respond according to a response policy indicated in or by the control frame. The AP 105-a may respond with a response message 220 to the STA 110-a. Once the STA 110-a receives the response message 220 from the AP 105-a, the STA 110-a may begin transmitting one or more data frames to the AP 105-a over the communication link 115-a.

The control frame may include a PHY header and at least one MPDU. The MPDU may in some instances include at least one of a CTS message or an ACK message. The STA 110-a may configure the PHY header of the control frame to indicate a first response policy for the MPDU that supersedes a second response policy for the MPDU specified by or otherwise associated with the MPDU at the MAC layer, such as an ACK policy of the MPDU. The AP 105-a may receive the control frame and send one or more response messages 220 to the STA 110-a according to the first response policy.

Additionally or alternatively, the STA 110-a may configure a synchronization block of the PHY header of the control frame to include a reduced set of synchronization bits different from an expanded set of synchronization bits.

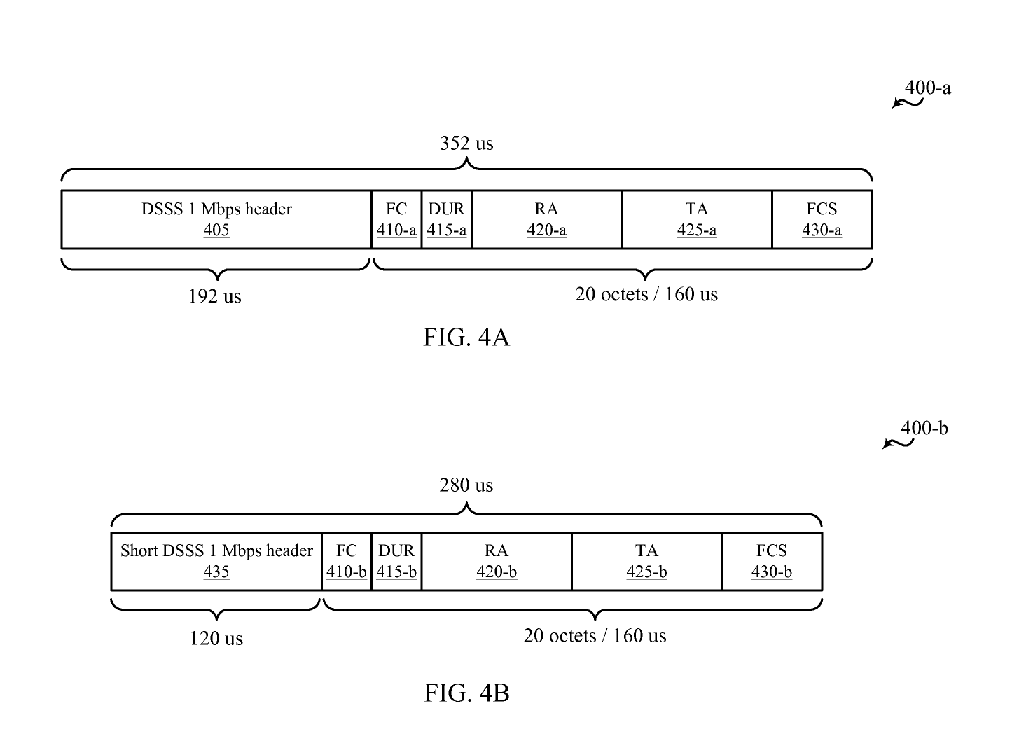

By utilizing the first response policy that is independent of the second response policy associated with the one or more MPDUs of the control frame, or using a synchronization block including a reduced set of synchronization bits, overhead for response policy messaging may be reduced, as will be described in further detail with reference to FIGS. 4A-8 below.

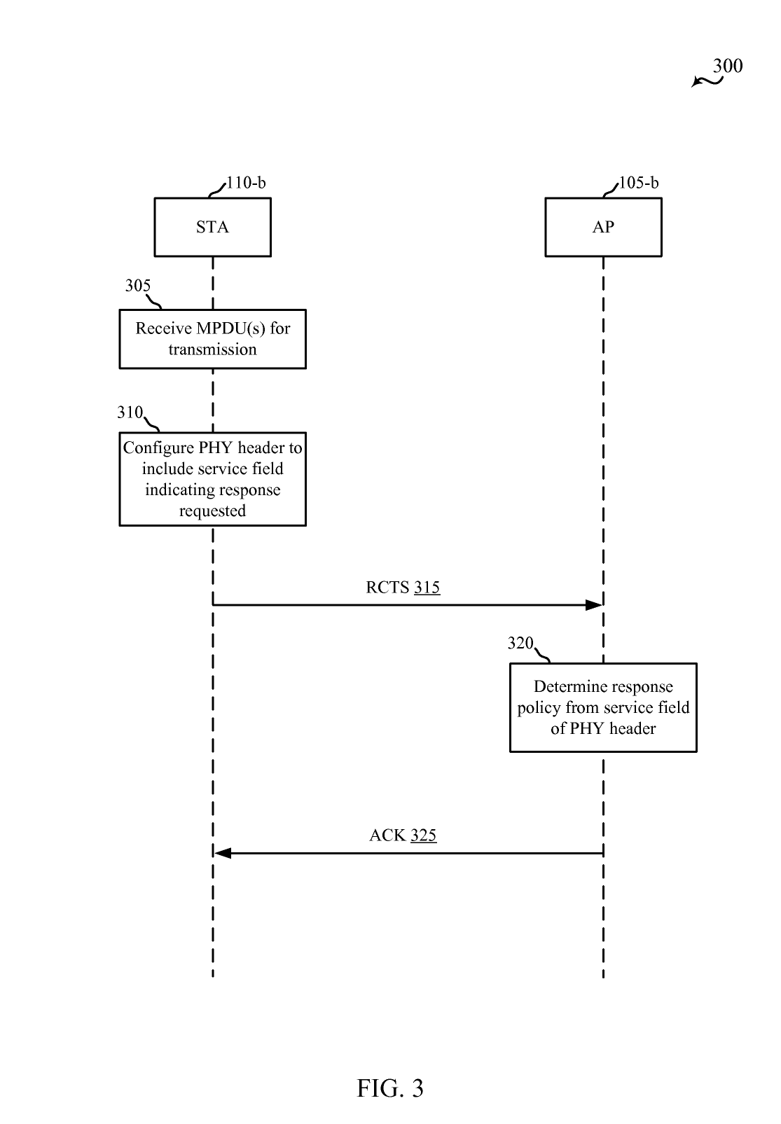

Referring now to FIG. 3, a system 300 illustrates exemplary communications between a STA 110-b and an AP 105-b, in accordance with the techniques described herein. The AP 105-b and STA 110-b may be examples of AP 105 and STA 110 described above in reference to FIG. 1 or 2. Furthermore, system 300 may be an example of, a portion of, or used by network 100 or system 200 described in reference to FIG. 1 or 2.

At block 305 the PHY layer of the STA 110-b may receive one or more MPDUs for transmission to an AP 105-b, for example from the MAC layer of the STA 110-b. At block 310, the STA 110-b may then configure a PHY header of a control frame to include a service field indicating that a response to the control frame is requested. The STA 110-b may then assemble a control frame including the PHY header and the one or more MPDUs. The one or more MPDUs may include at least one of a CTS or ACK message. The response policy indicated in the PHY header may supersede one or more response policies associated with the individual MPDUs at the MAC layer. The control frame containing the superseding response policy for the MPDU(s) in the PHY header may be referred to as a Response Request Clear to Send (RCTS) frame, and may be used in place of a traditional RTS frame to initiate the establishment of a communication link. The RCTS frame may utilize fewer resources than a traditional RTS frame. The amount of resources utilized for RTS/CTS messaging may be reduced.

The STA 110-b may transmit the RCTS frame 315 to the AP 105-b. At block 320, the AP 105-b may determine a response policy from the service field of the PHY header of the RCTS frame. The AP 105-b may send an ACK message 325 according to the determined response policy. Upon receiving the ACK message, the STA 110-b may then begin transmitting data to the AP 105-b.

Blocks 305, 310, or 315 may be performed by the PHY layer of the STA 110-b. In other examples, other layers of the STA 110-b may perform one or more of blocks 305, 310, or 315.

With reference now to FIG. 4A, a block diagram illustrates an example of an expanded Request to Send (RTS) frame 400-a. Expanded RTS frame 400-a may be used in any of network 100 or systems, 200, or 300 described above in reference to FIG. 1, 2, or 3. The expanded RTS frame 400-a may include an expanded PHY header 405 or preamble, which may be a PHY header, a Frame Control (FC) field 410-a, a Duration (DUR) field 415-a, a Receiver Address (RA) field 420-a, a Transmitter Address (TA) field 425-a, and a Frame Check Sequence (FCS) field 430-a.

Generally a RTS frame, such as expanded RTS frame 400-a, consists of 20 octets plus the length of the expanded PHY header 405 or preamble. The FC field 410-a may be 2 octets and may indicate that the frame is a RTS frame. The DUR field 415-a may also be 2 octets and may indicate the duration of the expanded RTS frame 400-a. The RA field 420-a may be 6 octets and may indicate an address of the receiving device. Similarly, the TA field 425-a may also be 6 octets and may indicate an address of the transmitting device. The FCS field 430-a may be 4 octets and may be used for error detection, via techniques well known in the art.

A RTS frame, such as expanded RTS frame 400-a, may incur significant overhead when transmitted at a low PHY rate, for example at 1 Megabits per second (Mbps) Direct Sequence Spread Spectrum (DSSS) PHY, as per 802.11. The entire expanded RTS frame 400-a, when transmitted at 1 Mbps DSSS PHY, may be 352 μs in length, with the expanded PHY header 405 comprising 192 μs and the FC field 410-a in combination with the DUR field 415-a, the RA field 420-a, the TA field 425-a, and the FCS field 430-a comprising 160 μs.

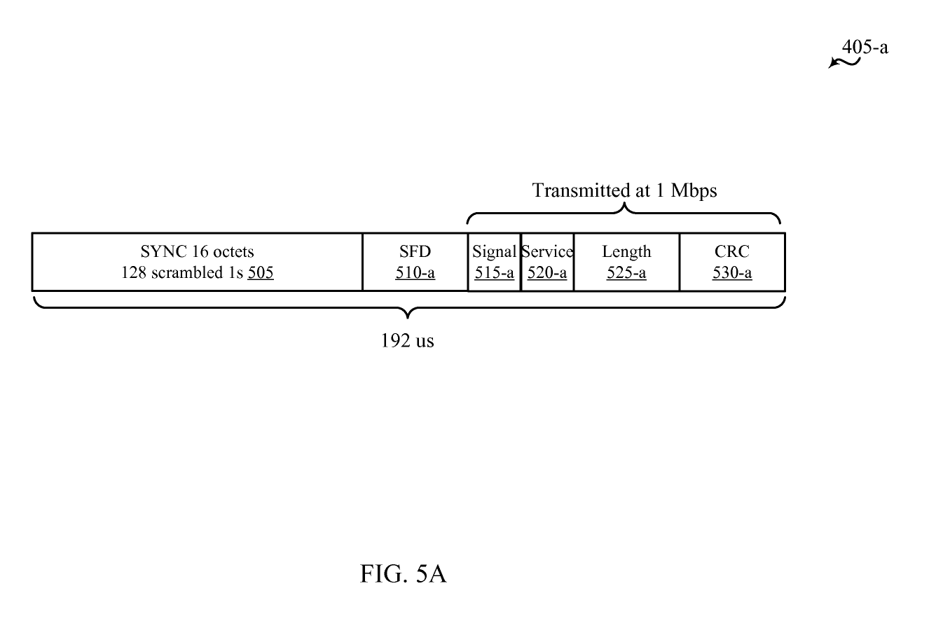

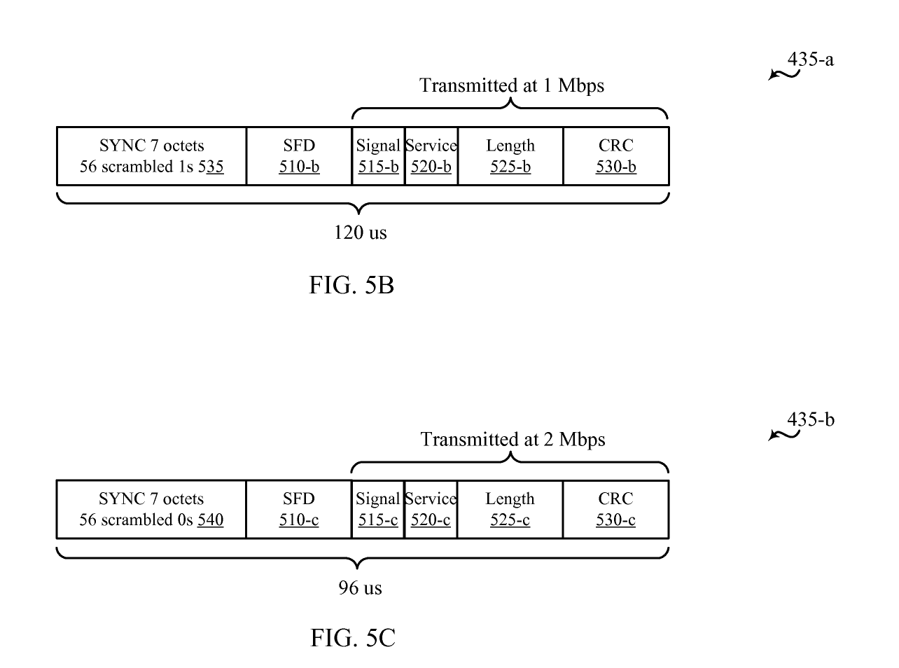

With reference now to FIG. 4B, a reduced RTS frame 400-b is shown with a reduced DSSS 1 Mbps PHY header 435 or preamble. The FC field 410-b, DUR field 415-b, RA field 420-b, TA field 425-b, and the FCS field 430-b of RTS frame 400-b may each include the same information and utilize the same resources as FC field 410-a, DUR field 415-a, RA field 420-a, TA field 425-a, and FCS field 430-a of the expanded RTS frame 400-a described above in reference to FIG. 4A. However, the reduced PHY header 435 may be reduced such that the reduced PHY header 435 utilizes less resources than the PHY header 405 of expanded RTS frame 400-a. The reduced PHY header 435 may be 120 μs in length, and combined with the FC field 410-b, DUR field 415-b, RA field 420-b, TA field 425-b, and the FCS field 430-b having a combined length of 160 μs may reduce the length of RTS frame 400-b to 280 μs from the length of 352 μs of expanded RTS frame 400-a. The reduced PHY header 435 and the configuration thereof will be discuss in greater detail below in reference to FIGS. 5A-5C.

With reference now to FIG. 5A, a block diagram of an example of an expanded PHY header 405-a or preamble, such as the PHY header 405 or preamble of FIG. 4A, is shown. The expanded PHY header 405-a, which may be 192 μs in length, may include a synchronization (SYNC) block 505, a Start Frame Delimiter (SFD) field 510-a, a Signal field 515-a, a Service field 520-a, a Length field 525-a, and a Cyclic Redundancy Check (CRC) field 530-a.

The SYNC block 505 may be 16 octets in length and include 128 scrambled 1 s. 128 bits may be referred to as an expanded set of synchronization bits. The SFD field 510-a may be 2 octets in length and may indicate that a long preamble, e.g. 128 bits, is being used in expanded PHY header 405-a, such as by the sequence f3a0h. The Signal field 515-a may be 1 octet in length and may indicate the PHY rate at which the payload attached to expanded PHY header 405-a is being transmitted. For example, the Signal field 515-a may include the sequence a0h and indicate a rate of 1 Mbps. The SYNC block 505 and the SFD field 510-a may indicate that the Signal field 515-a, the Service field 520-a, the Length field 525-a, or the CRC field 530-a may also be transmitted at a specified rate, for example 1 Mbps.

The Service field 520-a may generally be unused or reserved and may be 1 octet in length. The Service field 520-a may be used to indicate a first response policy for the control frame, for example RTS frames 400-a, 400-b, that supersedes a response policy associated with one or more attached MPDUs, as will be described in greater detail below. The Length field 525-a may be 2 octets and may indicate the length of the attached MPDUs. The CRC field 530-a may be 2 octets and may be used for error detection via techniques well known in the art.

With reference now to FIG. 5B, a block diagram of an example of a reduced PHY header 435-a or preamble, such as the reduced PHY header 435 or preamble of FIG. 4B, is shown. The reduced PHY header 435-a, which may be 120 μs in length, may be reduced compared to expanded PHY header 405-a and may include a SYNC block 535, a Start Frame Delimiter (SFD) field 510-b, a Signal field 515-b, a Service field 520-b, a Length field 525-b, and a Cyclic Redundancy Check (CRC) field 530-b.

The SYNC block 535 of reduced PHY header 435-a may be 7 octets in length and include 56 scrambled 1 s. 56 bits may be referred to as a reduced set of synchronization bits when compared with the expanded set of synchronization bits. Any other number of bits in the SYNC block 535 may also be referred to as a reduced set of synchronization bits, such as 64 or 72 bits, for example. The SFD field 510-b may be 2 octets in length and may indicate that a long preamble, also referred to herein as an expanded set of synchronization bits, e.g. 128 bits, is being used in reduced PHY header 435-a, such as by the sequence f3a0h. The other fields of the reduced PHY header 435-a may be configured in a similar manner to those fields with similar numbering of the expanded PHY header 405-a, and will not be repeated here for brevity.

The reduced SYNC block 535 in combination with the SFD field 510-b indicating that a long preamble, e.g. 128 bits, is utilized for the reduced PHY header/preamble 435-a may allow other devices, such as STAs 110 and APs 105, to treat and decode a control frame including a reduced PHY header 435, 435-a or preamble in the same way as a control frame with a long PHY header or preamble (e.g. the PHY headers 405, 405-a with a 128 bit SYNC field). In this way, the control frame may be configured with the reduced PHY preambles 435-a, 435, but still treated as though the control fame included a long PHY header or preamble, e.g. the PHY headers 405, 405-a or preambles of FIG. 4A or 5A. This configuration may allow for compatibility with systems and networks utilizing multiple 802.11 standards, such as 802.11b, for example. By using a reduced SYNC block 535 with 56 scrambled 1 s, reduced PHY header 435-b may be compatible with systems and devices implementing 802.11b. The reduced SYNC block 535 may, as a result, decrease the resources utilized by the header/preamble for control frame/RTS/CTS messaging, for example from 192 μs to 120 μs.

With reference now to FIG. 5C, a block diagram of an example of a reduced PHY header 435-b or preamble, such as the reduced PHY header 435 or preamble of FIG. 4B, is shown. The reduced PHY header 435-b, which may be 96 μs in length, may be reduced compared to expanded PHY header 405-a and may include a SYNC block 540, a Start Frame Delimiter (SFD) field 510-c, a Signal field 515-c, a Service field 520-c, a Length field 525-c, and a Cyclic Redundancy Check (CRC) field 530-c.

The SYNC block 540 may be 7 octets in length and include 56 scrambled 0 s. 56 scrambled 0 s may indicate that the control frame supports devices implementing 802.11b standards, such as the High Rate (HR) DSSS reduced header formats. The SFD field 510-c of reduced PHY header 435-b may include an inverted f3a0h sequence that indicates reduced PHY header 435-b includes a reduced HR DSSS PHY header. The Signal field 515-c of reduced PHY header 435-b may include the sequence “14h” and may indicate that reduced PHY header 435-b or the attached MPDUs may be transmitted at a rate of 2 Mbps. The other fields of the reduced PHY header 435-b may be configured in a similar manner to those fields with similar numbering of PHY headers 405-a, 435-a, and will not be repeated here for brevity.

By using a reduced SYNC block 540 with 56 scrambled 0 s, reduced PHY header 435-b of FIG. 5C may be differentiated from reduced PHY header 435-a of FIG. 5B, and thus may be compatible with systems and devices implementing 802.11b. Transmitting the subsequent fields at 2 Mbps may result decrease the duration of a reduced PHY header from 192 μs to 120 μs.

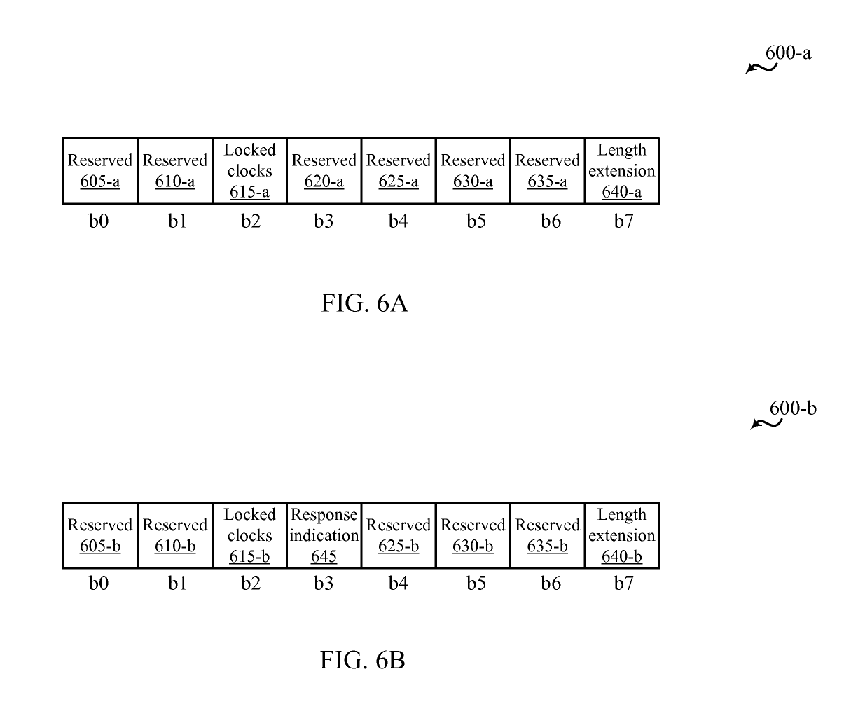

Referring now to FIGS. 6A and 6B, block diagrams of examples of Service fields 600-a, 600-b, such as Service fields 520 of FIGS. 5A-5C, are shown. Each Service field 600-a, 600-b, may include 8 bits, b0-b7. Generally for 1 Mbps DSSS PHY header implementations, most or all of the bits b0-b7 are reserved. For example, in Service field 600-a, bits b0 605-a, b1 610-a, b3 620-a, b4, 625-a, b5 630-a, and b6 635-a are reserved. Bit b2 615-a is locked, such as for clock operation, and bit b7 640-a includes a length extension value, for example.

In Service field 600-b, a bit, for example bit b3, may be replaced with a response indication value 645. The response indication value may indicate a first response policy for the control frame that supersedes a second response policy associated with the one or more attached MPDUs. The response indication value 645 set to 1 may indicate that a response is requested, whereas the response indication value 645 set to 0 may indicate that the second response policy of the one or more attached MPDUs is to be followed. More than 1 bit may be used in the service field 600-b to indicate further instructions concerning a first response policy for a control frame. In this way, one or more bits may be used in the service field 520, 600 of a PHY header of a control frame to indicate a first response policy that supersedes a second response policy specific to one or more attached MPDUs.

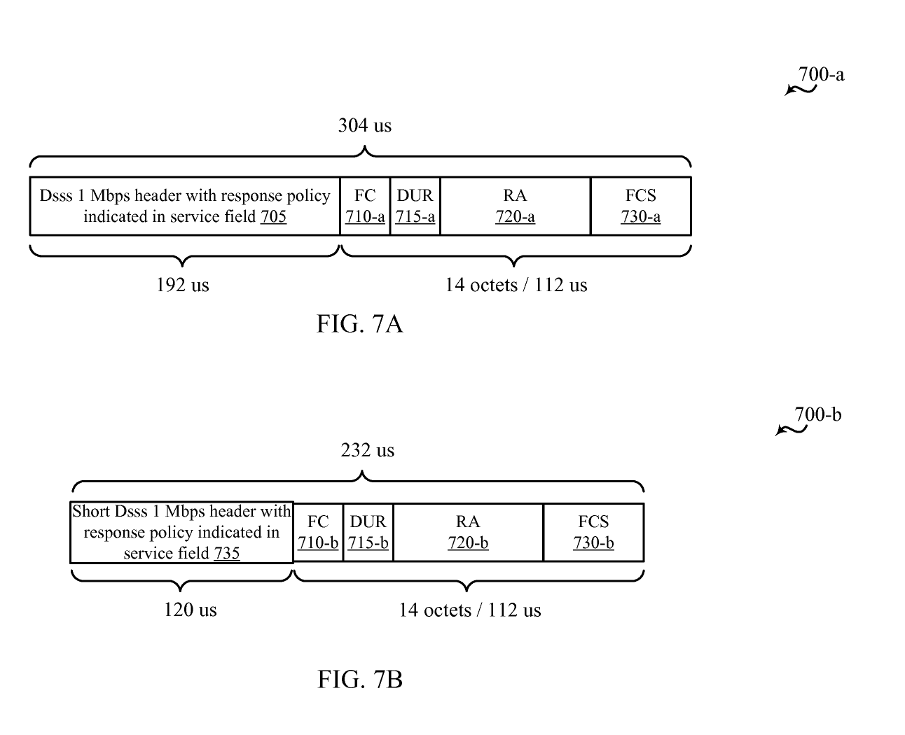

With reference now to FIG. 7A, a block diagram illustrates an example of a modified control frame 700-a. Modified control frame 700-a may be used in any of network 100 or systems, 200, or 300 described above in reference to FIG. 1, 2, or 3. The modified control frame 700-a may include an expanded PHY header 705 or preamble, which may be an example of expanded PHY header 405-a described in reference to FIG. 5A, with a first response policy indicated in the service field of the expanded PHY header 705, a Frame Control (FC) field 710-a, a Duration (DUR) field 715-a, a Receiver Address (RA) field 720-a, and a Frame Check Sequence (FCS) field 730-a.

The modified control frame 700-a may be configured as a CTS frame, with the expanded PHY header 705 modified to indicate a response policy, e.g., similar to expanded RTS frame 400-a but without the TA field 425-a. The modified control frame 700-a may be used in place of an RTS frame, such as expanded RTS frame 400-a, to reduce overhead of control frame messaging. In one implementation, such as when the modified control frame 700-a is configured for a DSSS 1 Mbps PHY header, the FC field 710-a, DUR 715-a, RA field 720-a, and FCS field 730-a may be 14 octets in length, e.g. 112 μs. This reduced length may reduce the radio resources utilized by the modified control frame 700-a from the 352 μs utilized by the expanded RTS frame 400-a to 304 μs (e.g., expanded RTS frame 400-a without the TA field 425-a).

With reference now to FIG. 7B, a block diagram illustrates another example of a modified control frame 700-b. Modified control frame 700-b may be used in any of network 100 or systems, 200, or 300 described above in reference to FIG. 1, 2, or 3. The modified control frame 700-b may include a reduced PHY header 735 or preamble with a first response policy indicated in the service field of the reduced PHY header 735, a Frame Control (FC) field 710-b, a Duration (DUR) field 715-b, a Receiver Address (RA) field 720-b, and a Frame Check Sequence (FCS) field 730-b.

The modified control frame 700-b may be configured as a CTS frame, with the reduced PHY header 735 modified to indicate a response policy, e.g., similar to RTS frame 400-b without the TA field 425-b. The modified control frame 700-b may be used in place of an RTS frame, such as the RTS frames 400-a or 400-b of FIGS. 4A-4B, to reduce overhead of control frame messaging. In one implementation, such as when the modified control frame 700-b is configured for a DSSS 1 Mbps PHY header, the FC field 710-b, DUR 715-b, RA field 720-b, and FCS field 730-b may be 14 octets in length, e.g. 112 μs. This reduction in length may reduce the radio resources utilized by modified control frame 700-b from 352 μs utilized by expanded RTS frame 400-a to 304 μs (see FIG. 7A). Modified control frame 700-b may utilize fewer resources than modified control frame 700-a by utilizing the reduced PHY header 735, which may be an example of reduced PHY header 435-a described in reference to FIG. 5B. This reduction in preamble length may further reduce radio resource usage by an additional 72 μs. In this way, by using an indication of a response policy in the PHY header of a control frame, or utilizing a reduced set of synchronization bits in a SYNC block of the PHY header, resources utilized by control frame messaging may be reduced, such as from to 352 μs to 232 μs.

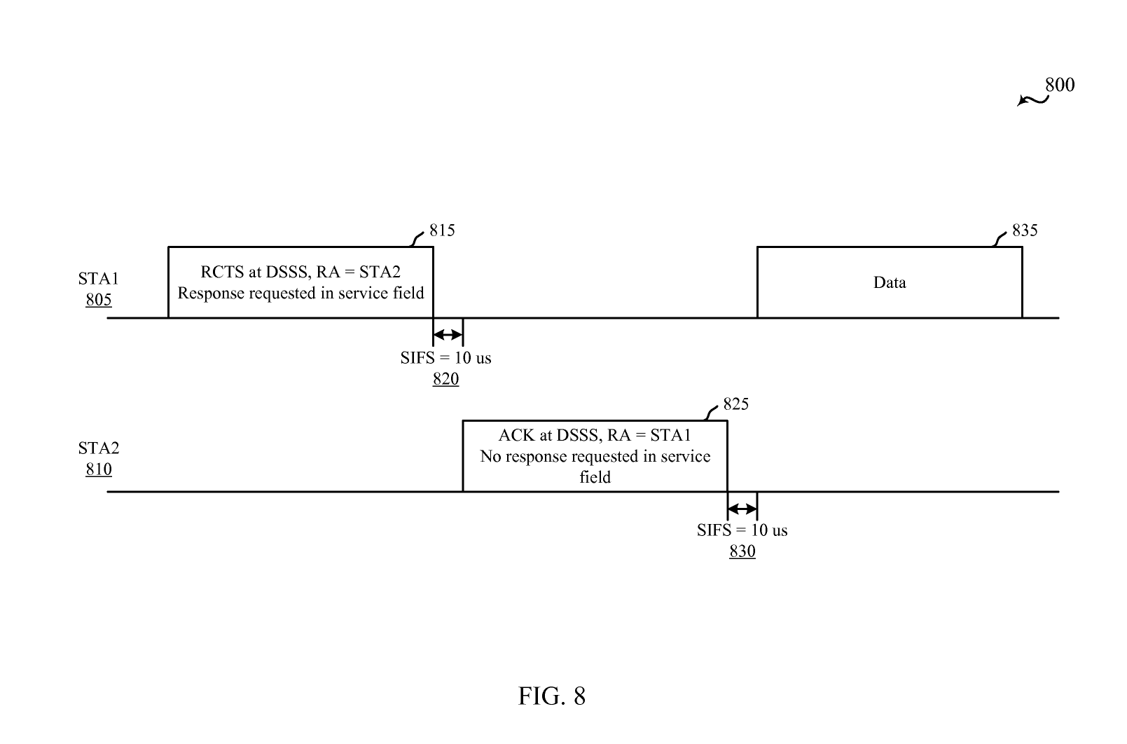

With reference now to FIG. 8, a block diagram of communications 800 between two STAs 805, 810 utilizing the techniques described herein for reducing overhead of control messaging, is shown. The STAs 805, 810 may be examples of one or more of the STAs 110 described in previous Figures. Communications 800 between STAs 805, 810 may be implemented in one or more of network 100 or systems, 200, or 300 described above in reference to FIG. 1, 2, or 3, and may implement one or more of the control frames or messages described in reference to FIG. 2, 3, 4A, 4B, 7A, or 7B.

STA 1 805 may configure and transmit a modified control frame 815 (e.g., also referred to as an RCTS frame), which may be one or more of the modified control frames 700-a, 700-b described above, to STA 2 810. The STA 1 805 may indicate the intended recipient device by setting the RA field to an address indicating STA 2 810. The STA 1 805 may set a bit in the service field of the PHY header of the modified control frame 815 to indicate that a response is requested, per the techniques described above. A Short Frame Space (SIFS) of, for example 10 μs, may transpire before the STA 2 810 receives the modified control frame. The STA 2 810 may then configure and transmit an ACK message 825 back to STA 1 805, according to the response policy indicated in the PHY header of modified control frame 815. The STA 2 810 may configure the ACK message, which may also be in the same format as the modified control frame 815, to indicate that no response is requested upon receipt of the ACK message. Thus, the modified control frame 815 may transmit an expanded RTS frame, and the ACK message 825 may replace an expanded CTS message. The processing and radio resources used to transmit and receive the modified control frame 815 and the related ACK message 825 may be less than what is used to send and receive an expanded RTS/CTS pair. In some cases, STA 2 810 may indicate the intended recipient by setting the RA field in the PHY header to the address of STA 1 805.

A SIFS of, for example 10 μs, may transpire before the STA 1 805 receives the ACK frame. The STA 1 805 may then begin to transmit data 835 to STA 2 810, over a communication link established via the RCTS and ACK message exchange.

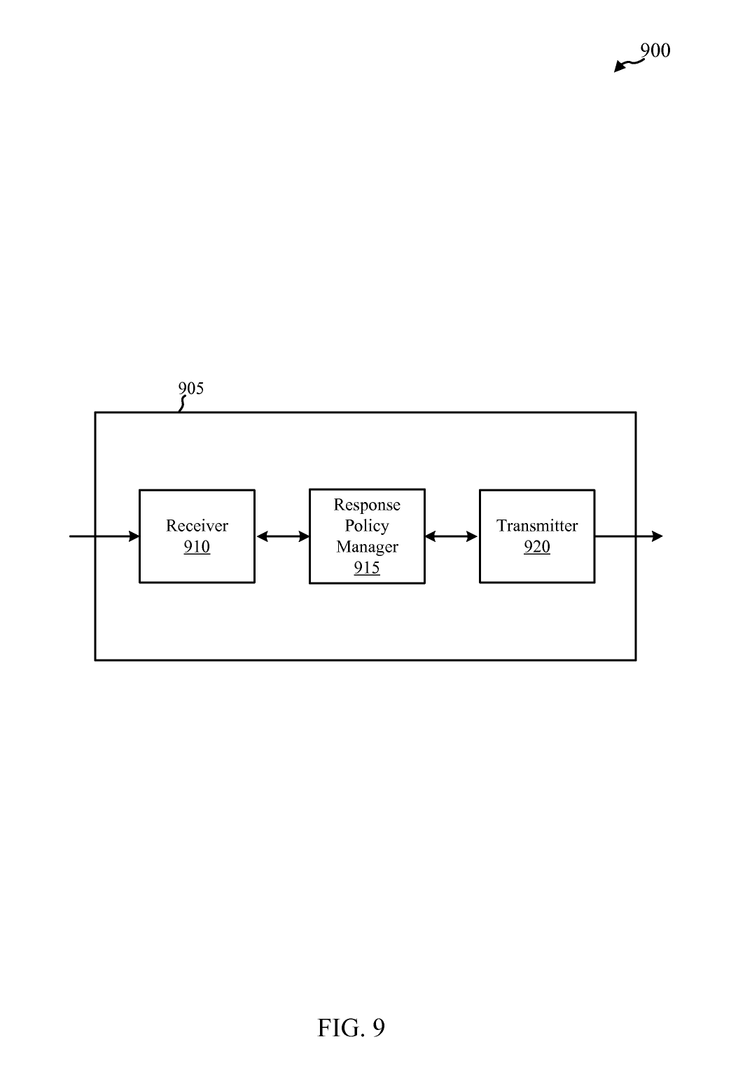

FIG. 9 shows a block diagram 900 illustrating an example of a device 905 that may be configured for reducing overhead of one or more control frames in accordance with various embodiments. The device 905 may be an example of one or more aspects of the APs 105 or STAs 110 described above in reference to previous Figures. The device 905 may also be a part of or operate within network 100 or systems 200, or 300 described in reference to FIG. 1, 2, or 3. The device 905 may include a receiver 910, a response policy manager 915, or a transmitter 920, each of which, in embodiments, may be communicably coupled with any or all of the other components.

The receiver 910 may be used to receive various types of data or control signals over a wireless communications system such as network 100 or systems 200, or 300 described in reference to FIG. 1, 2, or 3. As such, the receiver 910, either alone or in combination with other components, may be means for communicating as described herein.

The transmitter 920 may be used to transmit various types of data or control signals over a wireless communications system such as network 100 or systems 200, or 300. As such, the transmitter 920, either alone or in combination with other components, also may be means for communicating.

The response policy manager 915 may be configured to indicate a first response policy for one or more MPDUs in a PHY header of a control frame, for example, used to initiate establishment of a communication link by requesting access to a wireless medium. The control frame may include an RCTS frame and may be transmitted in place of a RTS frame. The first response policy may supersede a second response policy for the one or more MPDUs associated with the MPDUs to be packaged in the control frame. The response policy manager 915 may set one or more bits in a service field of the PHY header of the control frame to indicate the first response policy. The first response policy may indicate that a response is requested, or may indicate that the second response policy associated with the one or more MPDUs of the control frame may be followed.

The response policy manager 915 may communicate the configured PHY header to the transmitter 920, where the header may be attached to the one or more MPDUs to configure the control frame. The control frame may be an example of the modified control frames 700-a or 700-b described in reference to FIG. 7A or 7B. Some or all of the configuring of the control frame may be performed at the response policy manager 915. The transmitter 920 may then transmit the control frame, for example to an AP 105 or STA 110 to initiate the establishment of a communication link to access a wireless medium.

The receiver 910 may receive a response to the transmitted control frame, according to the response policy indicated in the PHY header of the control frame. Upon confirmation of the communication link by the received response message, which may include a CTS or ACK message, the device 905 may then transmit data to the recipient device via transmitter 920.

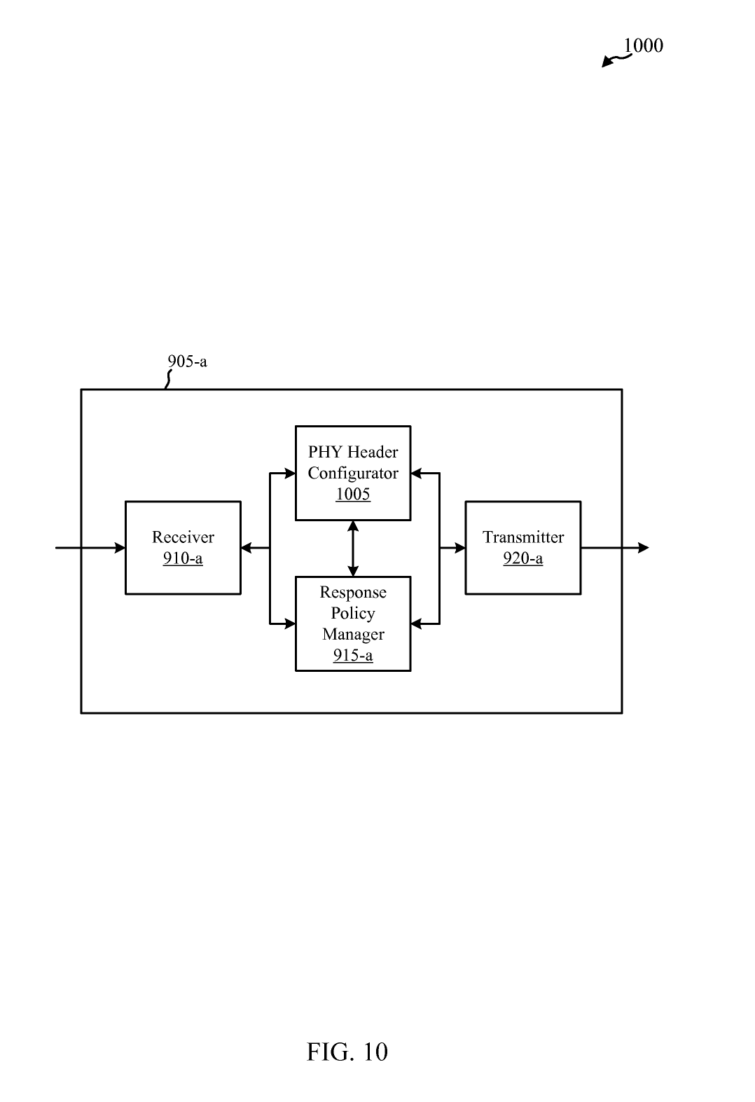

FIG. 10 shows a block diagram 1000 illustrating another example of a device 905-a that may be configured for reducing overhead of one or more control frames in accordance with various embodiments. The device 905-a may be an example of one or more aspects of the APs 105, STAs 110, or device 905 described in reference to previous Figures. The device 905-a may also be a part of or operate within network 100 or systems 200, or 300 described in reference to FIG. 1, 2, or 3. The device 905-a may include a receiver 910-a, a response policy manager 915-a, a PHY header configurator 1005, or a transmitter 920-a, each of which, in embodiments, may be communicably coupled with any or all of the other components.

The receiver 910-a or the transmitter 920-a may operate in a similar fashion as described above with respect to receiver 910 and transmitter 920 of FIG. 9, and so for the sake of brevity, will not be repeated here.

The response policy manager 915-a may be configured to indicate a first response policy for one or more MPDUs in a PHY header of a control frame. The first response policy may supersede a second response policy for the one or more MPDUs associated with the MPDUs to be packaged in the control frame. The response policy manager 915 may set one or more bits in a service field of the PHY header of the control frame to indicate the first response policy. The first response policy may indicate that a response is requested, or may indicate that the second response policy associated with the one or more MPDUs of the control frame may be followed.

The PHY header configurator 1005 may configure a synchronization block of the PHY header of the control frame to include a reduced set of synchronization bits. The reduced set of synchronization bits may include 56 scrambled 1 s, for example. The reduced set of synchronization bits may be different from an expanded set of synchronization bits, such as 128 bits, for example, including 128 scrambled 1 s. For example, the reduced set may include 64, 72 or any other number of bits less than 128 bits.

The response policy manager 915 in conjunction with the PHY header configurator 1005, may configure the control frame according to the reduced set of synchronization bits in the synchronization block and according to the response policy indicated in the PHY header. The control frame may be an example of the modified control frame 700-b described in reference to FIG. 7B. The response policy manager 915 or the PHY header configurator 1005 may communicate the configured control frame to the transmitter 920-a to be transmitted to the recipient device. In this way, overhead of the control frame and associated communications may be reduced in establishing a communication link to utilize a wireless medium.

The PHY header configurator 1005 may configure the synchronization block of the PHY header of the control frame to include a reduced set of synchronization bits different from an expanded set of synchronization bits independently of or without any operation of the response policy manager 915-a. In this way, the PHY header configurator 1005 may, in conjunction with the transmitter 920-a, transmit a control frame, such as control frame 400-b described in reference to FIG. 4B.

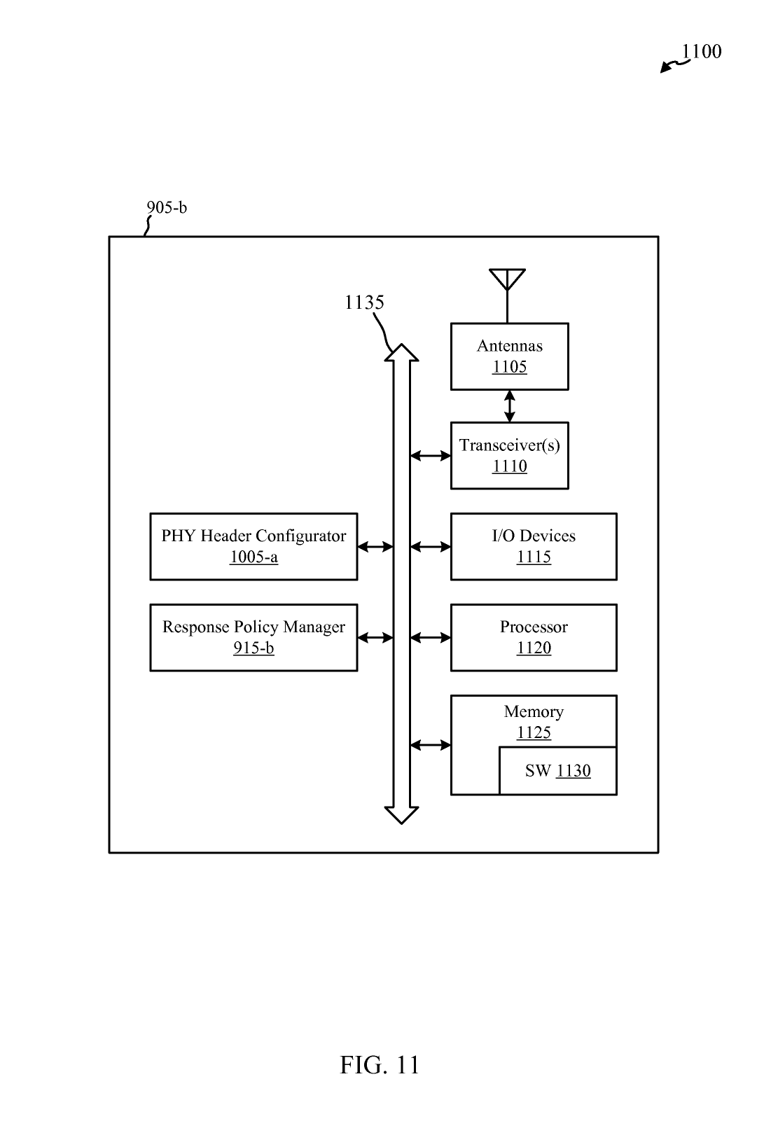

FIG. 11 is a block diagram 1100 of a device 905-b that may be configured for reducing overhead of one or more control frames in accordance with various embodiments. The device 905-b may be an example of one or more aspects of APs 105, STAs 110, or devices 905, 905-a described in reference to previous Figures. The device 905-b may also be a part of or operate within network 100 or systems 200, or 300 described in reference to FIG. 1, 2, or 3. The device 905-b may have any of various configurations, such as personal computers (e.g., laptop computers, netbook computers, tablet computers, etc.), smartphones, cellular telephones, PDAs, wearable computing devices, digital video recorders (DVRs), internet appliances, gaming consoles, e-readers, display devices, printers, etc. The device 905-b may have an internal power supply (not shown), such as a small battery, to facilitate mobile operation.

The device 905-b includes antenna(s) 1105, a transceiver 1110, memory 1125, a processor 1120, and I/O devices 1115 (e.g., a display, touch-screen interface, buttons, etc.), which each may be in communication, directly or indirectly, with each other, for example, via one or more buses 1135. The transceiver 1110 is configured to communicate bi-directionally, via the antennas 1105 over one or more wired or wireless communication links 115, 120, as described above. For example, the transceiver 1110 may be configured to communicate bi-directionally with other wireless devices or STAs 110 or APs 105 via communication links, such as communication links 115, 120 as described above with reference to previous Figures. The transceiver 1110 may include a modem configured to modulate packets or control frames and provide the modulated packets or control frames to the antennas 1105 for transmission, and to demodulate packets or control frames received from the antennas 1105. The transceiver 1110 may be configured to maintain multiple concurrent communication links using the same or different radio interfaces (e.g., Wi-Fi, cellular, etc.). The device 905-b may include a single antenna 1105, or the device 905-b may include multiple antennas 1105. The device 905-b may be capable of employing multiple antennas 1105 for transmitting and receiving communications in a MIMO communication system.

The memory 1125 may include random access memory (RAM) and read-only memory (ROM). The memory 1125 may store computer-readable, computer-executable software code 1130 containing instructions that are configured to, when executed, cause the processor 1120 to perform various functions described herein. Alternatively, the computer-executable software code 1130 may not be directly executable by the processor 1120 but may be configured to cause the computer (e.g., when compiled and executed) to perform functions described herein. The processor 1120 may include an intelligent hardware device, e.g., a central processing unit (CPU), a microcontroller, an application specific integrated circuit (ASIC), etc.

According to the architecture of FIG. 11, the device 905-b further includes a response policy manager 915-b and a PHY header configurator 1005-a. The response policy manager 915-b and the PHY header configurator 1005-a may implement the techniques describe above for reducing the overhead of one or more control messages, as described in reference to previous Figures, and so for brevity will not be repeated here. By way of example, these components of the device 905-b may be in communication with some or all of the other components of the device 905-b via bus 1135. Additionally or alternatively, functionality of these components may be implemented via the transceiver 1110, as a computer program product stored in computer-executable software code 1130, or as one or more controller elements of the processor 1120.

The components of the device 905-b may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted components may be a means for performing one or more functions related to operation of the device 905-b.

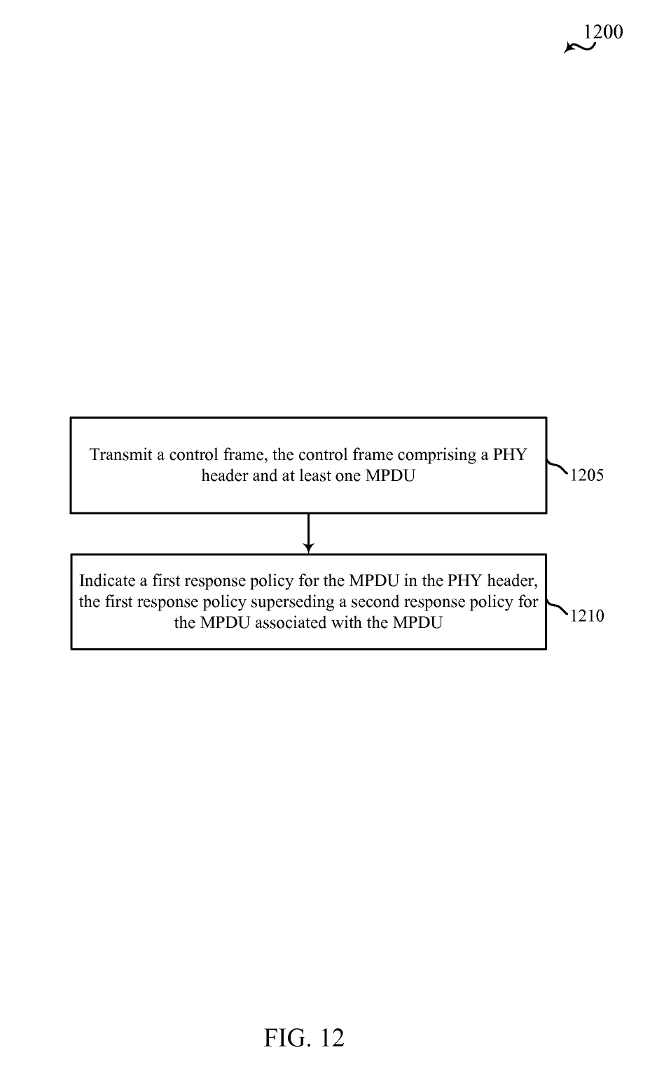

FIG. 12 is a flow chart illustrating one example of a method 1200 for reducing overhead of one or more control frames in accordance with various embodiments. For clarity, the method 1200 is described below with reference to one or more aspects of one of STAs 110, APs 105, or devices 905 described with reference to previous Figures. A device such as one of the devices 905 may execute one or more sets of codes to control the functional elements of the device 905 to perform the functions described below.

At block 1205, a device, such as device 905 of FIG. 9, 10, or 11 may transmit a control frame, the control frame comprising a PHY header and at least one MPDU to recipient device, such as a STA 110 or AP 105.

At block 1210, the device may indicate a first response policy for the MPDU in the PHY header, the first response policy superseding a second response policy for the MPDU associated with the MPDU. The device may set one or more bits in a service field of the PHY header to indicate the first response policy. The control frame may include a RCTS frame that is used for RTS/CTS signaling in place of an RTS frame.

Thus, the method 1200 may provide for reducing overhead of one or more control frames by indicating a response policy in a PHY header of the control frame. It should be noted that the method 1200 is just one implementation and that the operations of the method 1200 may be rearranged or otherwise modified such that other implementations are possible.

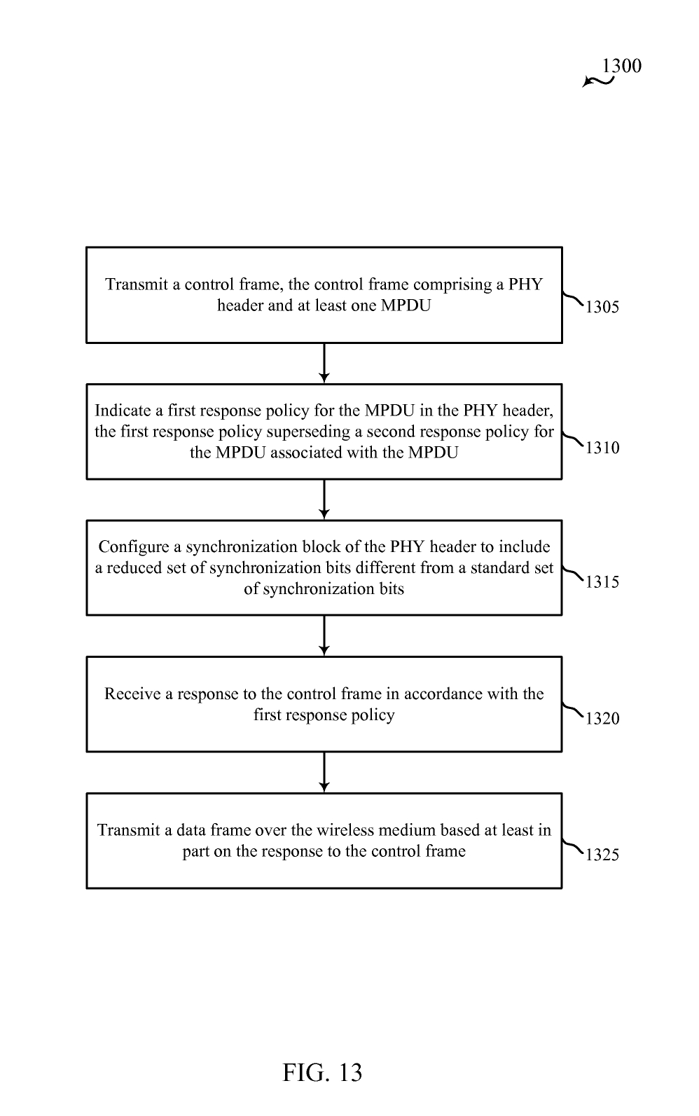

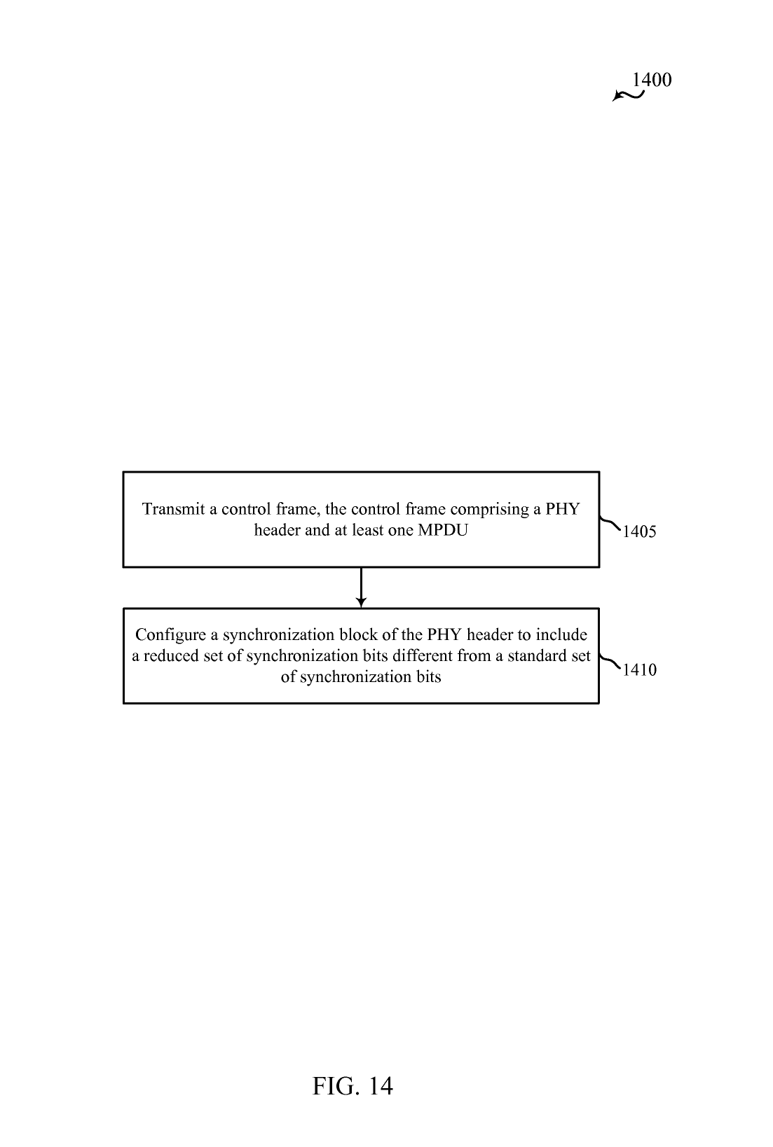

FIG. 13 is a flow chart illustrating one example of a method 1300 for reducing overhead of one or more control frames in accordance with various embodiments. For clarity, the method 1300 is described below with reference to one or more aspects of one of STAs 110, APs 105, or devices 905 described with reference to previous Figures. A device such as one of the devices 905 may execute one or more sets of codes to control the functional elements of the device 905 to perform the functions described below.

At block 1305, a device, such as device 905 of FIG. 9, 10, or 11 may transmit a control frame, the control frame comprising a PHY header and at least one MPDU to recipient device, such as a STA 110 or AP 105.

At block 1310, the device may indicate a first response policy for the MPDU in the PHY header, the first response policy superseding a second response policy for the MPDU associated with the MPDU. The device may set one or more bits in a service field of the PHY header to indicate the first response policy. The control frame may include a RCTS frame that is used for RTS/CTS signaling in place of an RTS frame.

At block 1315, the device may configure a synchronization block of the PHY header to include a reduced set of synchronization bits different from an expanded set of synchronization bits.

At block 1320, the device may receive a response to the control frame in accordance with the first response policy, for example form the recipient device, which may include an AP 105 or a STA 110.

At block 1325, the device may transmit a data frame over the wireless medium based at least in part on the response to the control frame.

Thus, the method 1300 may provide for reducing overhead of one or more control frames by indicating a response policy in a PHY header of the control frame and by using a reduced set of synchronization bits in the synchronization block of the PHY header. It should be noted that the method 1300 is just one implementation and that the operations of the method 1300 may be rearranged or otherwise modified such that other implementations are possible.

FIG. 14 is a flow chart illustrating one example of a method 1400 for reducing overhead of one or more control frames in accordance with various embodiments. For clarity, the method 1400 is described below with reference to one or more aspects of one of STAs 110, APs 105, or devices 905 described with reference to previous Figures. A device such as one of the devices 905 may execute one or more sets of codes to control the functional elements of the device 905 to perform the functions described below.

At block 1405, a device, such as device 905 of FIG. 9, 10, or 11 may transmit a control frame, the control frame comprising a PHY header and at least one MPDU to recipient device, such as a STA 110 or AP 105.

At block 1410, the device may configure a synchronization block of the PHY header to include a reduced set of synchronization bits different from an expanded set of synchronization bits. The device may further configure the PHY header, such as the synchronization block or an SFD field of the PHY header, to indicate that an expanded set of synchronization bits are associated with the PHY header. In this way, the control frame may be compatible with other systems that utilize a reduced set of synchronization bits without any confusion as to what transmission is being employed by the control frame.

Thus, the method 1400 may provide for reducing overhead of one or more control frames using a reduced set of synchronization bits in the synchronization block of the PHY header. It should be noted that the method 1400 is just one implementation and that the operations of the method 1400 may be rearranged or otherwise modified such that other implementations are possible.

Techniques described herein may be used for various wireless communications systems such as an IEEE 802.11 (Wi-Fi, Wi-Fi P2P, Wi-Fi Direct, etc.) system. The techniques described herein may be used for the systems and radio technologies mentioned above as well as other systems and radio technologies. The description above, however, describes a WLAN system for purposes of example, and WLAN terminology is used in much of the description above, although the techniques are applicable beyond WLAN applications.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks, components, and modules described in connection with the disclosure herein may be implemented or performed with an at least one general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communication, comprising:
transmitting a control frame, the control frame comprising a physical layer (PHY) header and at least one medium access control (MAC) protocol data unit; and
indicating a first response policy for the MAC protocol data unit in the PHY header, the first response policy superseding a second response policy for the MAC protocol data unit associated with the MAC protocol data unit.

2. The method of claim 1, further comprising:
transmitting the control frame in place of a Request to Send (RTS) frame to request access to a wireless medium.

3. The method of claim 2, further comprising:
receiving a response to the control frame in accordance with the first response policy; and
transmitting a data frame over the wireless medium based on the response to the control frame.

4. The method of claim 1, wherein the MAC protocol data unit comprises one of a Clear To Send (CTS) or an Acknowledgment (ACK) message.

5. The method of claim 1, wherein the PHY header comprises a service field, and wherein indicating in the PHY header the first response policy for the MAC protocol data unit comprises setting a bit in the service field of the PHY header based on the first response policy.

6. The method of claim 1, wherein the first response policy indicated in the PHY header comprises one of a response request or an indication to follow the second response policy associated with the at least one MAC data unit.

7. The method of claim 5, wherein the bit set in the service field of the PHY header based on the first response policy is separate from at least one high rate direct sequence spread spectrum (HR) (DSSS) bit in the service field of the PHY header.

8. The method of claim 1, wherein the second response policy associated with the MAC protocol data unit comprises an Acknowledgment (ACK) policy of the MAC protocol data unit.

9. The method of claim 1, wherein the PHY header comprises a synchronization block comprising a reduced set of synchronization bits.

10. The method of claim 9, wherein the PHY header further comprises a start frame delimiter (SFD) field, and wherein the SFD field indicates that the synchronization block comprises an expanded set of synchronization bits different from the reduced set of synchronization bits.

11. The method of claim 10, wherein the synchronization block indicates that the synchronization block comprises the expanded set of synchronization bits.

12. The method of claim 11, wherein the PHY header further comprises a signal field, a service field, a length field, and a cyclic redundancy check field, and wherein the synchronization block and the SFD field indicate that the signal field, the service field, the length field, and the cyclic redundancy check field are transmitted at 1 Mbps.

13. A wireless communications apparatus comprising:
a transmitter to transmit a control frame comprising a physical layer (PHY) header and at least one medium access control (MAC) protocol data unit; and
a response policy manager to indicate a first response policy for the MAC protocol data unit in the PHY header, the first response policy superseding a second response policy for the MAC protocol data unit associated with the MAC protocol data unit.

14. The wireless communications apparatus of claim 13, wherein the transmitter is further to transmit the control frame in place of a Request to Send (RTS) frame to request access to a wireless medium.

15. The wireless communications apparatus of claim 14, further comprising:
a receiver to receive a response to the control frame in accordance with the first response policy;
wherein the transmitter is further to transmit a data frame over the wireless medium based on the response to the control frame.

16. The wireless communications apparatus of claim 13, wherein the MAC protocol data unit comprises one of a Clear To Send (CTS) or an Acknowledgment (ACK) message.

17. The wireless communications apparatus of claim 13, wherein the PHY header comprises a service field, and wherein indicating in the PHY header the first response policy for the MAC protocol data unit comprises setting a bit in the service field of the PHY header based on the first response policy.

18. The wireless communications apparatus of claim 13, wherein the first response policy indicated in the PHY header comprises one of a response request or an indication to follow the second response policy associated with the at least one MAC data unit.

19. The wireless communications apparatus of claim 17, wherein the bit set in the service field of the PHY header based on the first response policy is separate from at least one high rate direct sequence spread spectrum (HR) (DSSS) bit in the service field of the PHY header.

20. The wireless communications apparatus of claim 13, wherein the second response policy associated with the MAC protocol data unit comprises an Acknowledgment (ACK) policy of the MAC protocol data unit.

21. An apparatus for wireless communication, comprising:
means for transmitting a control frame, the control frame comprising a physical layer (PHY) header and at least one medium access control (MAC) protocol data unit; and
means for indicating a first response policy for the MAC protocol data unit in the PHY header, the first response policy superseding a second response policy for the MAC protocol data unit associated with the MAC protocol data unit.

22. The apparatus of claim 21, further comprising:
means for transmitting the control frame in place of a Request to Send (RTS) frame to request access to a wireless medium.

23. The apparatus of claim 22, further comprising:
means for receiving a response to the control frame in accordance with the first response policy; and
means for transmitting a data frame over the wireless medium based on the response to the control frame.

24. The apparatus of claim 21, wherein the MAC protocol data unit comprises one of a Clear To Send (CTS) or an Acknowledgment (ACK) message.

25. The apparatus of claim 21, wherein the PHY header comprises a service field, and wherein indicating in the PHY header the first response policy for the MAC protocol data unit comprises setting a bit in the service field of the PHY header based on the first response policy.

26. The apparatus of claim 21, wherein the first response policy indicated in the PHY header comprises one of a response request or an indication to follow the second response policy associated with the at least one MAC data unit.

27. A non-transitory computer-readable medium storing instructions executable by a processor to cause at least one device to:
transmit a control frame, the control frame comprising a physical layer (PHY) header and at least one medium access control (MAC) protocol data unit; and
indicate a first response policy for the MAC protocol data unit in the PHY header, the first response policy superseding a second response policy for the MAC protocol data unit associated with the MAC protocol data unit.

28. The non-transitory computer-readable medium of claim 27, further comprising instructions executable by the processor to cause the at least one device to:
transmit the control frame in place of a Request to Send (RTS) frame to request access to a wireless medium.

29. The non-transitory computer-readable medium of claim 27, further comprising instructions executable by the processor to cause the at least one device to:
receive a response to the control frame in accordance with the first response policy; and
transmit a data frame over the wireless medium based on the response to the control frame

30. The non-transitory computer-readable medium of claim 27, wherein the MAC protocol data unit comprises one of a Clear To Send (CTS) or an Acknowledgment (ACK) message.
